(19) United States
(12) Patent Application Publication
(10) Pub. No.: US 2008/0229349 A1
(43) Pub. Date: Sep. 18, 2008

(54) Recordable optical data storage disc

(76) Inventors: Richard R. Ollmann, Woodbury, MN (US); Stanley C. Busman, North St. Paul, MN (US); Roger C. Culhane, Stillwater, MN (US); Mark R. Drutowski, St. Paul, MN (US); Terry L. Morkved, White Bear Lake, MN (US); Daniel P. Stubbs, Marine on St. Croix, MN (US)

Correspondence Address: Attention: Eric D. Levinson;Imation Corp., Legal Affairs, P.O. Box 64898, St. Paul, MN, 55164-0898, US

(21) Appl. No.: 11/725,131

(22) Filed: Mar. 15, 2007

(51) Int. Cl. G11B 7/24

(52) U.S. Cl. 720/709

(57) ABSTRACT

A recordable data storage disc comprises a substrate having a spirally or concentrically shaped groove pattern. A groove depth of the groove pattern is greater than 90 nanometers, and a track pitch provided by the groove pattern is less than 500 nanometers. The data storage disc further comprises a write-once recording layer formed on the groove pattern, and a reflector layer formed on the recording layer opposite the substrate. The groove depth of greater than 90 nanometers allows a thicker coating of dye to be used for the recording layer compared to other recordable data storage discs with a groove pattern with a groove depth of 90 nanometers or less. The thicker coating of dye allows a lower write power, better modulation when reading a data signal from the disc. The groove depth of greater than 90 nanometers may also allow for more precise push-pull tracking.

### TECHNICAL FIELD

The invention relates to recordable optical data storage discs.

### BACKGROUND

High capacity optical data storage media, such as High Definition Digital Video Discs (HD-DVD) or Blu-Ray discs, provides a smaller track pitch than a conventional DVD disc, which allows the high capacity media to store more data than a conventional DVD of the same size. For example, HD-DVDs have a track pitch of approximately 400 nanometers (nm), and Blu-Ray discs have a track pitch of approximately 320 nm. In contrast, DVDs have a track pitch of approximately 740 to 800 nm.

In order to read the smaller tracks, HD-DVD and Blu-Ray players utilize lasers with shorter wavelengths compared to DVD players. For example, HD-DVD and Blu-Ray players both use a 405 nm blue-violet laser. In contrast, a DVD player uses a red 650 nm laser. The shorter wavelength of lasers used in high capacity data storage disc players reduces diffraction and maintains a smaller spot size necessary to differentiate the smaller tracks.

Recordable optical data storage discs include a recording layer. The reflectivity of the recording layer can be altered using heat, e.g., from a laser. For example, heating the recording layer may produce a localized deformation. Other recordable optical data storage discs include a dye that undergoes a phase-change in the recording layer resulting in the localized change in reflectivity. A multitude of localized variations in reflectivity organized in a spiral or concentric pattern is used to store digital data. In write-once optical data storage discs, the change in reflectivity is relatively permanent, whereas in rewriteable optical data storage discs, the change in reflectivity is reversible such that different data may be stored at the same physical location at different times.

### SUMMARY

In general, the invention is directed to a high capacity recordable optical media having a substrate with track groove depths of greater than 90 nm. A recording layer including a commercially available dye is coated on the substrate, filling the grooves. Compared to recordable optical media with groove depths less than 90 nm, a thicker coating of the dye can be used for the recording layer. The thicker coating of dye allows lower writing power to be used and better modulation in a data signal retrieved from the recorded portions of the disc. The groove depths greater than 90 nm may also allow for more precise push-pull tracking. Overall, these benefits of groove depths greater than 90 nm may improve bit error rates in both reading and writing to the media compared to recordable optical media with groove depths less than 90 nm. In this manner, embodiments of the invention provide reliable high capacity recordable optical media such as HD-DVDs and Blu-Ray discs.

In one embodiment, the invention is directed to a data storage disc comprising a substrate having a spirally or concentrically shaped groove pattern. A groove depth of the groove pattern is greater than 90 nanometers, and a track pitch provided by the groove pattern is less than 500 nanometers. The data storage disc also includes a write-once recording layer located on the groove pattern and a reflector layer adjacent to the recording layer opposite the substrate.

In another embodiment, the invention is directed to a method comprising forming a substrate having a spirally or concentrically shaped groove pattern. A groove depth of the groove pattern is greater than 90 nanometers, and a track pitch provided by the groove pattern is less than 500 nanometers. The method also includes coating a solution including a low-to-high reflectivity dye on the groove pattern to form a recording layer and metallizing a reflector layer formed on the recording layer opposite the substrate.

In another embodiment, the invention is directed to a data storage disc comprising a write-once recording layer, and a means for providing a push-pull value greater than 0.35. The data storage disc has a data storage capacity greater than 10 gigabytes.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1A is a conceptual illustration of a system including a recordable optical data storage disc with a spiral groove pattern having a groove depth greater than 90 nm and an optical head with a laser emitter and a four-division photodetector.

FIG. 1B is a close-up illustration of the four-division photodetector shown in FIG. 1A.

FIG. 2 is an illustration of a cross-section of a recordable optical data storage disc with a groove depth greater than 90 n.

FIG. 3 is an illustration of a cross-section of a recordable optical data storage disc with a groove depth greater than 90 nm showing exemplary push-pull signals corresponding to different radial positions on the recordable optical data storage disc.

FIG. 4 is a spin profile that may be used to spin coat a recording layer on top of a molded substrate in the production of a recordable optical data storage disc with a groove pattern having a groove depth greater than 90 nm.

FIG. 5 is a flowchart illustrating an exemplary method of manufacturing a recordable optical data storage disc with a groove pattern having a groove depth greater than 90 nm.

### DETAILED DESCRIPTION

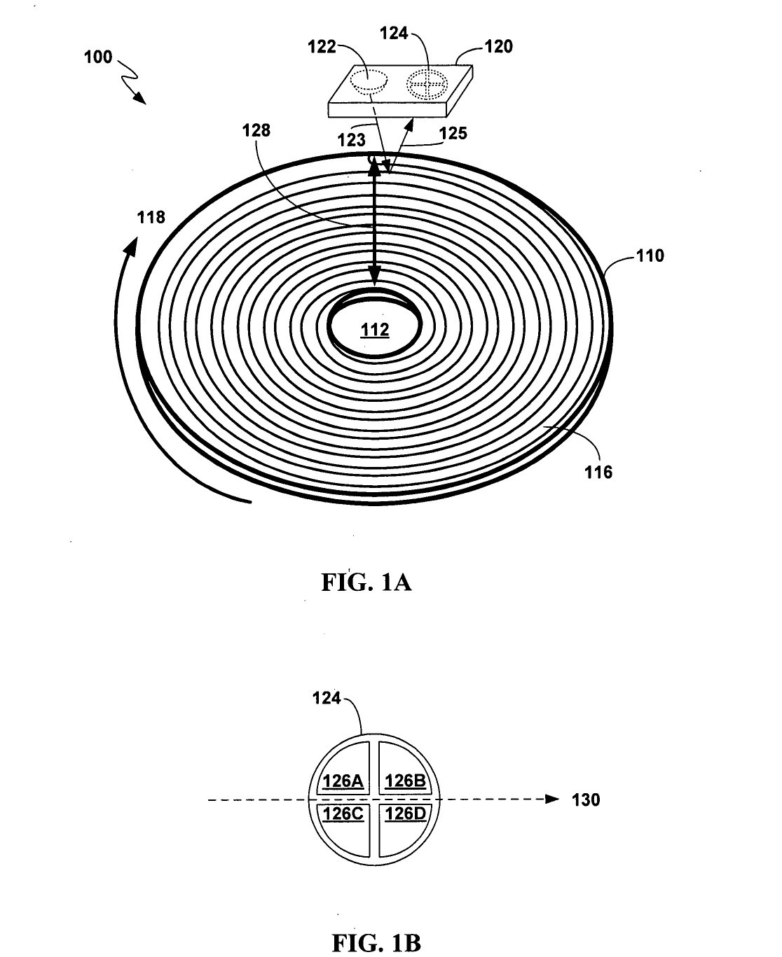

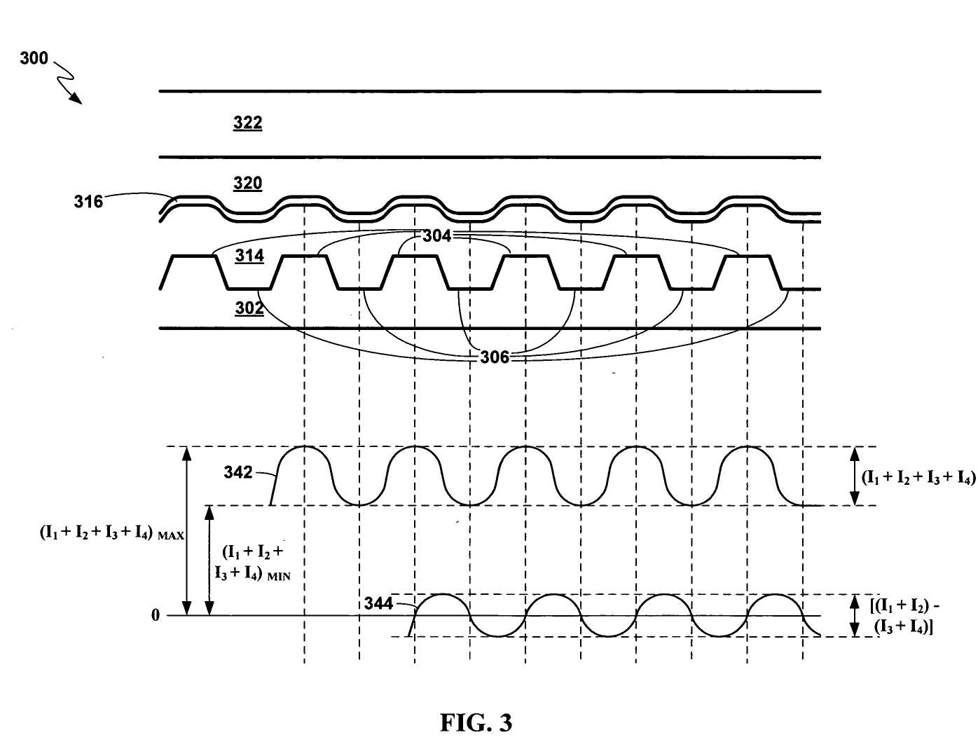

FIG. 1A is a conceptual illustration of system 100, which includes recordable optical data storage disc 110 and optical head 120. Data storage disc 110 includes a substrate with spiral groove pattern 116. Spiral groove pattern 116 has a groove depth greater than 90 nm and a track pitch of less than 500 nm. A recording layer is coated over groove pattern 116 below the surface of the substrate that is adjacent to optical head 120. A reflective metal layer covers the recording layer on the side opposite to optical head 120. Optical head 120 includes laser emitter 122 and four-division photodetector 124, which is operable to read data recorded on data storage disc 110 and to produce a tracking signal as described in greater detail with respect to FIG. 3.

During operation of system 100, data storage disc 110 is rotated in direction 118 on a spindle (not shown) at center hole 112. While data storage disc 110 is rotating, optical head 120 can be positioned at any radius along line 128 to read data recorded on data storage disc 110. The spindle motor (not shown) compensates for the radial position of optical head 120 to maintain a constant linear velocity of data storage disc 110 relative to optical head 120 at any radius.

Optical head 120 reads data from data storage disc 110 by emitting laser light 123 from laser emitter 122 and measuring a signal amplitude from four-division photodetector 124, which detects reflected laser light 125. The signal amplitude is dependent on the reflectivity of the recording layer, which varies to represent the data stored on data storage disc 110. For example, the recording layer may be a write-once recording layer with a low-to-high reflectivity dye.

FIG. 1B is a close-up illustration of four-division photodetector 124. Four division photodetector 124 detects reflected laser light 125. Each of detector quadrants 126A-126D (quadrants 126) produces a distinct signal according to a light intensity on the surface of each of quadrants 126. The combined signal amplitude of quadrants 126 may be used to read data on data storage disc 110. Differences in signal amplitude provide a push-pull signal to center optical head 120 about line 130, which represents the center of a groove of groove pattern 116.

Four-division photodetector 124 is also used to produce a push-pull signal to precisely maintain positioning of optical head 120 above the center of a groove in groove pattern 116. Comparative signal amplitudes of quadrants 126 provide push-pull tracking signals. For example, when optical head 120 including four-division photodetector 124 is positioned at the center of a groove of groove pattern 116 as represented by line 130, the combined light intensity of measured by quadrants 126A and 126B will be equal to the combined light intensity of measured by quadrants 126C and 126D. More specifically, the light intensity of measured by quadrant 126A will be equal to the light intensity measured by quadrant 126C, and the light intensity of measured by quadrant 126B will be equal to the light intensity measured by quadrant 126D. If optical head 120 deviates from line 130, the relative difference in measured light intensities can be used to reposition optical head on line 130. Exemplary tracking signals are described with respect to FIG. 3. As one example, a push-pull signal may be represented as:

$$Push - Pull = 2 * \frac{( {Intensity}_{126 A} + {Intensity}_{126 B} ) - ( {Intensity}_{126 C} + {Intensity}_{126 D} )}{( {Intensity}_{126 A} + {Intensity}_{126 B} ) + ( {Intensity}_{126 C} + {Intensity}_{126 D} )}$$

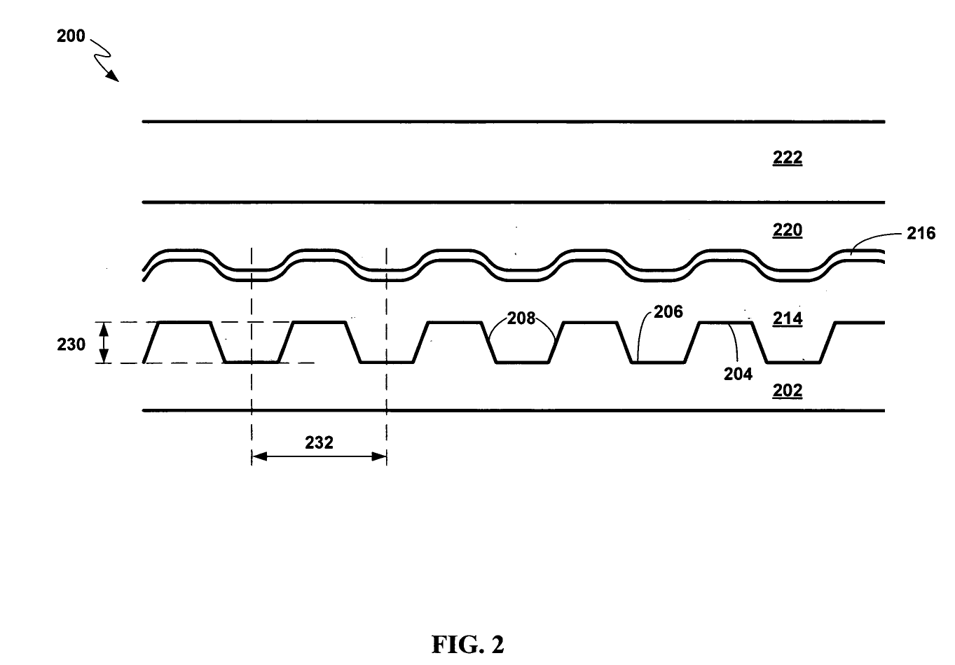

FIG. 2 is an illustration of a cross-section of recordable optical data storage disc 200. Recordable optical data storage disc 200 includes substrate 202, which has a spirally or concentrically shaped groove pattern with groove depth 230 greater than 90 nm. Data is stored in recording layer 214 along the spirally or concentrically shaped groove pattern. For example, recordable optical data storage disc 200 may be the same as recordable optical data storage disc 110 (FIG. 1).

Recording layer 214 located on the groove pattern of substrate 202. Reflector layer 216 is adjacent to recording layer 214 and opposite substrate 202. Reflector layer 216 may comprise, for example, a silver alloy or other metal. For example, reflector layer 216 may be approximately 150 nm thick. Reflector layer 216 is not flat, but instead follows the contour of grooved pattern of substrate 202. As will be described with respect to FIG. 3, the shape of reflector layer 216 is necessary to allow push-pull tracking of data storage disc 200. Opposite recording layer 214, smooth substrate 222 is bonded to reflector layer 216 with adhesive layer 220.

Substrate 202 may be an injection molded polycarbonate with a spirally or concentrically shaped groove pattern. The groove pattern provides lands 204 and grooves 206 with angled surfaces 208 separating lands 204 from grooves 206. Groove depth 230 is the distance between lands 204 and grooves 206. Track pitch 232 is the distance between the centers of grooves 206 and is less than 500 nm to provide a high capacity data storage disc. Track pitch 232 may also be less than 450 nm. For example, track pitch 232 may be approximately 400 nm (HD-DVD) or approximately 320 nm (Blu-Ray).

Groove depth 230 is greater than 90 nm. In various embodiments, groove depth 230 may be greater than 90 nm, greater than 100 nm, greater than 110 nm, greater than 120 nm, greater than 130 nm, greater than 140 nm, and even greater than 150 nm. In some embodiments, groove depth 230 may be between 90 nm and 150 nm. For example, groove depth 230 may be between 110 nm and 140 nm. Groove depth 230 may also be between 115 nm and 130 nm. For example, in some embodiments, groove depth 230 may be approximately 100 nm. In other embodiments, groove depth 230 may be approximately 120 nm. As will be described in greater detail with respect to FIG. 3, groove depth 230 relates to a push-pull signal value provided by data storage disc 200.

FIG. 3 is an illustration of a cross-section of recordable optical data storage disc 300 showing exemplary push-pull signals corresponding to different radial positions on recordable optical data storage disc 300. Recordable optical data storage disc 300 has the same structure as recordable optical data storage disc 200 (FIG. 2). For brevity, some details of data storage disc 300 described with respect to data storage disc 200 are not repeated in this description of data storage disc 300.

Recordable optical data storage disc 300 includes substrate 302, which has a spirally or concentrically shaped groove pattern with a groove depth greater than 90 nm. Data is stored in recording layer 314 along the spirally or concentrically shaped groove pattern. Reflector layer 316 is adjacent to recording layer 314 and opposite substrate 302. Reflector layer 316 approximates the contour of the grooved pattern of substrate 302. The shape of reflector layer 316 is necessary to allow push-pull tracking of data storage disc 300. Opposite recording layer 314, smooth substrate 322 is bonded to reflector layer 316 with adhesive layer 320.

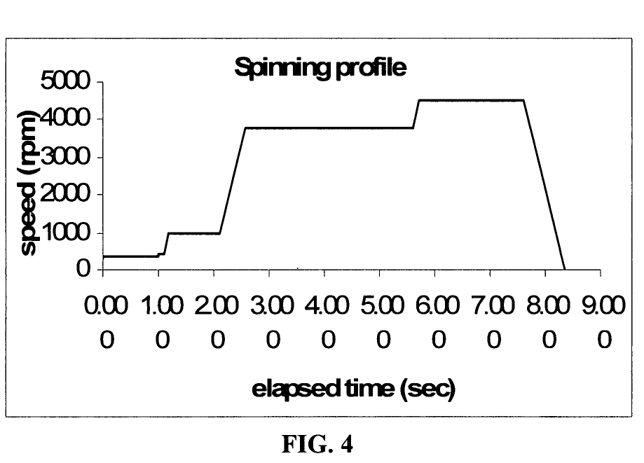

Two tracking signals are shown at various radii of data storage disc 300. Tracking signal 344 represent the net difference light intensity measurements for each half of a four-division photodetector, such as photodetector 124 (FIGS. 1A-1B). For example, with respect to photodetector 124, the combined light intensity of measured by quadrants 126C and 126D (I₃+I₄) may be subtracted from the combined light intensity of measured by quadrants 126A and 126B (I₁+I₂) to produce tracking signal 344. As shown in FIG. 4, if an optical head including the photodetector is positioned at the center of one of grooves 306 or the center of one of lands 304, tracking signal 344 will have an amplitude of zero. As the optical head deviates from the center of one of lands 304 or grooves 306, tracking signal 344 will have a non-zero amplitude that corresponds to the distance from the center of one of lands 304 or grooves 306 and to the depth of grooves 306 as transferred to reflector layer 316. In this manner, tracking signal 344 is useful to follow either one of lands 304 or grooves 306.

Tracking signal 342 may be used to distinguish between the center of lands 304 and grooves 304. Tracking signal 342 represents a sum of light intensity measurements at each quadrant of a four-division photodetector, such as photodetector 124 (FIGS. 1A-1B). When the optical head including the photodetector is positioned at the center of one of grooves 306, the sum of light intensity measurements is at its maximum. In contrast, when the optical head including the photodetector is positioned at the center of one of lands 304, the sum of light intensity measurements is at a minimum. Thus, tracking signal 342 can be used to clearly distinguish between lands 304 and grooves 306 and to follow grooves 306. The combined use of tracking signals 342 and 344 may provide greater tracking precision than using only a single tracking signal. Other tracking signals may also be used to increase precision. For example, the light intensity of measured by quadrant 126A may be compared only with the light intensity measured by quadrant 126C, and the light intensity of measured by quadrant 126B may be separately compared only with the light intensity measured by quadrant 126D to produce redundant tracking signals.

The amplitudes of tracking signals 342 and 344 are caused not only by the position of an optical head relative to lands 304 and grooves 306, but also by the depth of grooves 306 as transferred to reflector layer 316. The greater the depth of grooves 306, the greater change in signal amplitude in tracking signals 342 and 344 as a result of a radial movement relative to lands 304 and grooves 306. For this reason, increasing the depth of grooves 306 may allow for more precise tracking on data storage disc 300. Increasing tracking precision may improve bit error rates in both reading and writing to data storage disc 300.

Different dyes can be used in a write-once recording layer of a data storage disc. For example, a write-once recording layer can be formed by spin coating a dye solution spin coated on a substrate including a grooved pattern with a groove depth in excess of 90 nm. The dye solution may contain 0.4-3.0 percent PS-384, HD-400 or HD-450 dye (commercially available from Clariant Ltd., which is based in Switzerland) in a solvent, such as 2,2,3,3-tetrafluoro-1-propanol (TFP). The solution may be prepared by placing the dye in the solvent and ultrasonicating. For example, ultrasonicating may be performed for approximately five minutes.

Dyes suitable for recording layers include low to high reflectivity dyes which are activated by a laser having a wavelength of less than 500 nm. For example, a suitable low to high reflectivity dye may be activated by a laser having a wavelength of approximately 405 nm.

Other examples of dyes that may be used in recording layers include tris-2,4,6-(o-hydroxyaryl)-1,3,5-triazines; bis-Aromatic Schiff base metal complexes; indoline-thiophene compounds; merocyanine and phthalocyanine dyes; triazacyanine dyes; dyes that thermally cyclize to 5, 6, or 7-membered rings; heterocyclic azo dyes; cyanine dyes; cationic aminoheterocyclic dyes; hemicyanine dyes; diazahemicyanine dyes; xanthene dyes; bis-pyrrole-based squarylium dyes; polymer-bound merocyanines and amino vinyl ketones and nitriles; azo dyes, such as heterocyclic azo, merocyanines, hemicyanines, cyanines, strepto cyanines, zero cyanines, enamine, hydrazone, coumarins and phthalocyanines; (4n)-heptalenes dyes; aza monomethine and bis-aza trimethine cyanines; porphyrins; 6-hydroxy-2-pyridones; diketone enimines and their metal complexes; bis-azathiophene metal complexes; benzoxazolyl benzimidazol or benzofuranyl benzimidazol dyes; mono- or di-cationic naphthalene dicarboxylic or tetracarboxylic imides or diimides; bis styryl dyes; coumarin dyes; indoaniline metal complexes; 1,2,3-benzotriazole metal complexes; bis, tris, and tetra N-(ortho-hydroxyaryl)benzotriazoles; bis(benzotriazole)phenolic dyes; bis-[2-(hydroxyaryl)benzotriazines; styryl dyes; formazan metal complexes; pyrylium dyes; rhodacyanines; porphycenes and heterocyclic annulenes; PEDOT (poly(3,4-ethylenedioxy-thiophene); 4-methylidene dihydropyridines and dihydro 6-membered ring heterocycles; bicyclo compounds which thermally eject ethylene to form benzo-compounds; sulfonimines; 7-amino-carbostyril compounds; aromatic imides containing metallocene residues; coumarins; bis-naphthalene imides and bis-phthalimides attached with spacer group; bis-aryl acetylenes and tris-aryl-bis-acetylenes; polyacene diimides; ferrocene hydrazones; quinazolines; N-aryl aryl amides; phthalone metal complexes; pyridine-naphthalone; pyrimidines; 1,2,3-benzotriazole metal complexes; 3,5,6-triaryl-1,2,4-triazines; bibenzooxazinyl derivatives; monomethine metal complex dyes; bi-benzoxa/thiazolyl derivatives; quinazolinol derivatives directly bonded to indenedione derivates; arylene diamines; bisarylamines; azaquinolines; triamines; tetraamine derivatives; trisdiarylamino-triarylamine derivatives; metal azo, oxadiazole dyes; and also azaannulenes, including metal complexes.

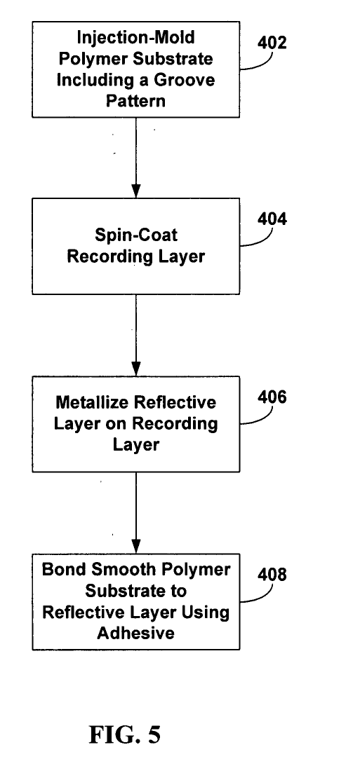

FIG. 5 is a flowchart illustrating exemplary techniques for manufacturing a high capacity recordable optical data storage disc. First, a substrate is formed to include a spiral or concentric groove pattern (402). A groove depth of the groove pattern is greater than 90 nm; e.g., the groove depth of the groove pattern may be between 90 nm and 150 nm. A track pitch provided by the groove pattern is less than 500 nm. For example, the substrate may be an injection-molded polycarbonate formed using stamper with a photoresist layer having the groove pattern.

Next, a solution including a low-to-high reflectivity dye is coated on the groove pattern to form a recording layer (404). For example, a solution including the low-to-high reflectivity dye and a solvent, such as 2,2,3,3-tetrafluoro-1-propanol (TFP), may be spin coated on the substrate according to the spin profile shown in FIG. 4. The dye-coated substrates may then be dried, e.g., in a forced air oven for approximately 60 minutes at approximately 80 degrees Celsius.

Once the dye solution is solidified to form the recording layer, a reflective layer is coated on the recording layer opposite the substrate (406). For example, the reflective layer may be a silver alloy approximately 150 nm thick. Last, a smooth substrate is bonded to the reflective layer opposite the recording layer using an adhesive (408).

The techniques described with respect to FIG. 5 were used to manufacture prototype recordable data storage discs. In general, each of the data storage discs were manufactured with reference to HD-DVD specifications. For example, each prototype has a track pitch of 400 nm. Taken as a whole, the prototypes demonstrate that a greater groove depth provides a greater push-pull value.

In a first series of prototypes, polycarbonate substrates were made from stampers prepared using a photoresist. The photoresist provided a spiral groove pattern, the groove depth varied for each prototype in the first series. A 1.3% solution of HD-400 dye (commercially available from Clariant Ltd., which is based in Switzerland) in 2,2,3,3-tetrafluoro-1-propanol (TFP) was prepared by placing the dye in solvent and ultrasonicating for five minutes. Solutions including 0.4 to 3.0 percent dye may also be used; for example, solutions including 1.1 to 1.4 percent dye. The dye solution was spin coated using the spin profile shown as FIG. 4 onto each polycarbonate substrate. For each disc, a silver reflector layer of approximately 150 nm was applied above the recording layer and a smooth polycarbonate substrate was bonded to the silver reflector layer with an adhesive. The discs were then tested for push-pull values.

For each prototype in the first series, both the thickness of the groove depth in the groove pattern of the photoresist and the actual groove depth of the polycarbonate substrate as measured by an atomic force microscope is shown below in Table 1. Table 1 also shows an average push-pull value as measured at 11 radii for each prototype.

TABLE 1

| Prototype | Photoresist Groove | Groove Depth on | Measured Push- |
|---|---|---|---|
| Number | Depth (nm) | Substrate (nm) | Pull Values |
| 1 | 70 | 68–74 | 0.29 |
| 2 | 90 | 83–87 | 0.35 |
| 3 | 110 | 98–103 | 0.41 |

In a second series of prototypes, polycarbonate substrates were made from stampers prepared using a 95 nm photoresist. The photoresist provided a spiral groove pattern. Each prototype in the second series provided a measured substrate groove depth of 80 nm. 1.1 to 1.4 percent solutions of HD-450 dye (commercially available from Clariant Ltd., which is based in Switzerland) in 2,2,3,3-tetrafluoro-1-propanol (TFP) was prepared by placing the dye in solvent and ultrasonicating for five minutes. Solutions including 0.4 to 3.0 percent dye may also be used; for example, solutions including 1.1 to 1.4 percent dye. The dye solution was spin coated using the modified spin profile shown as FIG. 4 onto each polycarbonate substrate. For each disc, a silver reflector layer of approximately 150 nm was applied above the recording layer and a smooth polycarbonate substrate was bonded to the silver reflector layer with an adhesive.

Measured push-pull values at a 37 millimeter radius were between 0.39 and 0.47 for each disc in the series. These push-pull values are within a range of 0.30 to 0.60 as defined in a proposed HD-DVD-R specification. The measured Partial Response Signal to Noise Ratio (PRSNR) for the discs was 17.0 to 26.5, which is also within the HD-DVD specification which requires a PRSNR greater than 15.

Each of the prototypes using the HD-400 dye with a measured groove depth of at least 83 nm provided a push-pull value of at least 0.35. Likewise, the prototypes using the HD-450 dye each had a measured groove depth of at least 90 nm and provided a push-pull value of at least 0.39. Furthermore, according to the HD-DVD specification, each prototype provides approximately 15 gigabytes of data storage capacity. While larger push-pull values may increase tracking precision for a data storage disc, push-pull values greater than 0.60 are outside of currently proposed HD-DVD-R specifications. For this reason, groove patterns with groove depths that provide a push-pull value of no more than 0.60 may be best suited for groove patterns in HD-DVD-Rs. In other formats, groove patterns with groove depths that provide push-pull values in excess of 0.60 may be useful.

Various embodiments of the invention have been described. For example, embodiments were described with respect to HD-DVD and Blu-Ray discs; however, other high-capacity optical data storage disc formats may also be used. Furthermore, embodiments were described with respect to single-sided, single layer discs, but the described techniques all apply to dual layer and/or dual sided discs. These and other embodiments are within the scope of the following claims.

1. A data storage disc comprising:
a substrate having a spirally or concentrically shaped groove pattern, wherein a groove depth of the groove pattern is greater than approximately 90 nanometers, wherein a track pitch provided by the groove pattern is less than approximately 500 nanometers;
a write-once recording layer located on the groove pattern; and
a reflector layer adjacent to the recording layer opposite the substrate.

2. The data storage disc of claim 1, wherein the groove depth of the groove pattern is greater than approximately 100 nanometers.

3. The data storage disc of claim 1, wherein the groove depth of the groove pattern is greater than approximately 130 nanometers.

4. The data storage disc of claim 1, wherein the groove depth of the groove pattern is greater than approximately 150 nanometers.

5. The data storage disc of claim 1, wherein the groove depth of the groove pattern is between approximately 90 nanometers and approximately 150 nanometers.

6. The data storage disc of claim 1, wherein the track pitch of the groove pattern is approximately 400 nanometers.

7. The data storage disc of claim 1, wherein the track pitch of the groove pattern is approximately 320 nanometers.

8. The data storage disc of claim 1, wherein the write-once recording layer includes a low to high reflectivity dye.

9. The data storage disc of claim 1, wherein the write-once recording layer comprises a low to high reflectivity dye which is activated by a laser having a wavelength of less than approximately 500 nanometers.

10. The data storage disc of claim 1, wherein the write-once recording layer comprises a low to high reflectivity dye which is activated by a laser having a wavelength of approximately 405 nanometers.

11. The data storage disc of claim 1, wherein the write-once recording layer includes 2,2,3,3-tetrafluoro-1-propanol (TFP).

12. The data storage disc of claim 1, wherein the substrate is a polycarbonate.

13. The data storage disc of claim 1, wherein the substrate is a first substrate, further comprising:
an adhesive layer adjacent the reflector layer; and
a second substrate layer adjacent the adhesive layer.

14. The data storage disc of claim 1, wherein the data storage disc has a data storage capacity greater than 10 gigabytes.

15. A method comprising:
forming a substrate having a spirally or concentrically shaped groove pattern, wherein a groove depth of the groove pattern is greater than approximately 90 nanometers, wherein a track pitch provided by the groove pattern is less than approximately 500 nanometers;
coating a solution including a low-to-high reflectivity dye on the groove pattern to form a recording layer; and
metallizing a reflector layer on the recording layer opposite the substrate.

16. The method of claim 15, wherein the substrate is a first substrate, the method further comprising bonding a second substrate to the reflector layer.

17. The method of claim 15, wherein the groove depth of the groove pattern is between approximately 90 nanometers and approximately 150 nanometers.

18. The method of claim 15, wherein forming the substrate includes injection molding a polymer using a stamper with a photoresist layer having the groove pattern.

19. A data storage disc comprising:
a write-once recording layer; and
a means for providing a push-pull value greater than approximately 0.35, wherein the data storage disc has a data storage capacity of greater than 10 gigabytes.

20. The data storage disc of claim 19, wherein the push-pull value is less than or equal to approximately 0.60.
